(19) United States
(12) Patent Application Publication
(10) Pub. No.: US 2009/0041330 A1
(43) Pub. Date: Feb. 12, 2009

(54) ENHANCED CHECK IMAGE DARKNESS MEASUREMENTS

(76) Inventors: Jeffrey E. Journey, Concord, NC (US); Ravinder Prakash, Concord, NC (US)

Correspondence Address: HOFFMAN WARNICK LLC, 75 STATE ST, 14 FL, ALBANY, NY, 12207, US

(21) Appl. No.: 11/834,858

(22) Filed: Aug. 7, 2007

(51) Int. Cl. G06K 9/00

(52) U.S. Cl. 382/139

(57) ABSTRACT

A system, method and program product for measuring darkness of a check image. A system is disclosed that includes a system for capturing MICR code line image data from the black white check image; a system for determining a darkness value from the captured MICR code line image data; and a system for determining if the black white check image is acceptable by comparing the darkness value to a threshold, and for outputting a resulting analysis.

### FIELD OF THE INVENTION

This disclosure relates generally to image quality metrics, and more particularly relates to a system and method of measuring darkness in a black white check image.

### BACKGROUND OF THE INVENTION

With the advent of check image based transactions and large check volumes, the ability to process checks automatically is critical for financial institutions. Accordingly, reducing the manual examination of check images as much as possible remains an important goal. This has driven a strong need for automation in determining whether the quality of a check image is “acceptable”. The industry has established that for a black white image, “darkness” is the most important image quality metric for providing the highest correlation to image quality and usability. The industry is routinely measuring image darkness and is practicing its use in accepting or rejecting an image.

Image darkness is defined as a percentage ratio of black pixels to the total image pixels. While the image darkness metric, defined as above is useful, it leads to many false positives, namely suspecting images that are otherwise useful. The suspected images lead to increased manual inspection, which is undesirable.

A flaw in the current use of image darkness measures is attributable to the wide variations in check designs. A simple “vanilla” check will have limited regions appearing as black and thus the image will be less dark. A busy “designer” check with a graphic background will have increased regions converted to black white, thus leading to a darker image. While both checks may be of acceptable quality, the darkness measure of the two checks may vary greatly. The result is that a “busy” check image may be labeled as too dark, thus suspected as unusable. Manual intervention may then be required. Accordingly, a need exists for a more robust method of measuring check image darkness.

### SUMMARY OF THE INVENTION

The present disclosure relates to a system, method and program product for measuring image darkness. Namely, image darkness is measured via image darkness of the code line, namely the images of the printed magnetic ink character recognition (MICR) characters. Given the fact that industry standards control the MICR printing characters, results in image darkness measurement are more reliable.

In one embodiment, there is a darkness measurement system for measuring darkness of a black white check image, comprising: a system for capturing MICR code line image data from the black white check image; a system for determining a darkness value from the captured MICR code line image data; and a system for determining if the black white check image is acceptable by comparing the darkness value to a threshold, and for outputting a resulting analysis.

In a second embodiment, there is a computer program product stored on a computer readable medium for measuring darkness of a black white check image, comprising: program code configured for capturing MICR code line image data from the black white check image; program code configured for determining a darkness value from the captured MICR code line image data; and program code configured for determining if the black white check image is acceptable by comparing the darkness value to a threshold, and for outputting a resulting analysis.

In a third embodiment, there is a method for measuring darkness of a black white check image, comprising: capturing MICR code line image data from the black white check image; determining a darkness value from the captured MICR code line image data; determining if the black white check image is acceptable by comparing the darkness value to a threshold; and outputting a resulting analysis.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a darkness measurement system in accordance with an embodiment of the present invention.

FIG. 2 depicts a series of MICR code line samples having varying darkness's.

FIG. 3 depicts a table showing darkness values collected from the MICR code line samples of FIG. 2.

FIG. 4 depicts a graph showing normalizes darkness values from the table of FIG. 3.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

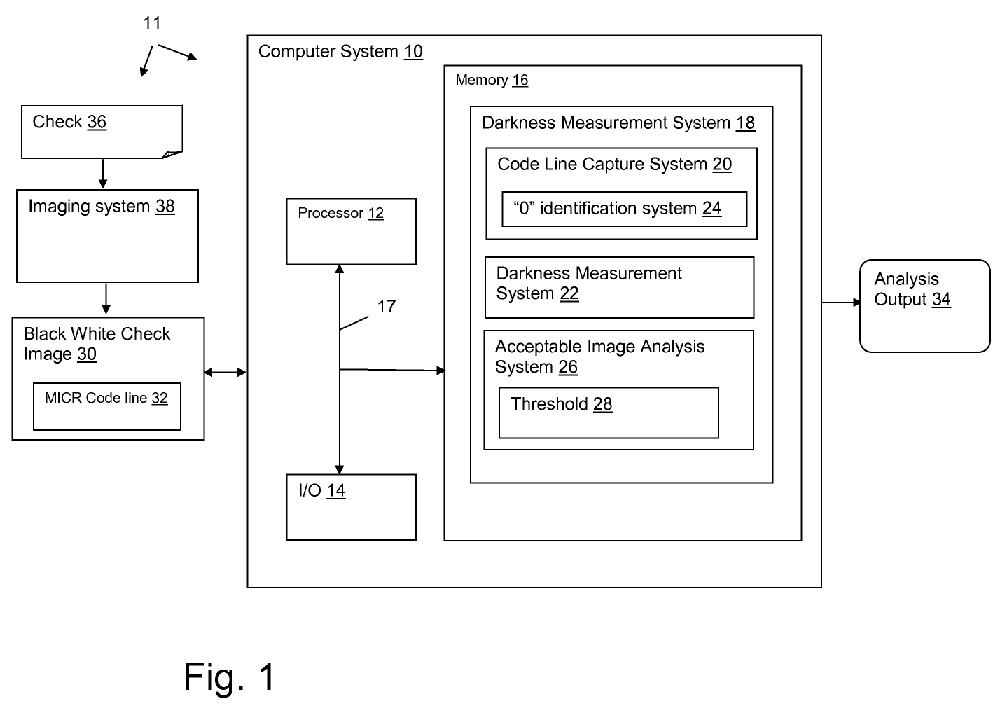

Referring now to the drawings, FIG. 1 depicts a check processing system 11 that includes a computer system 10 having a darkness measurement system 18 that measures a darkness of an inputted black white check image 30 and generates an analysis output 34. Black white check image 30 may for instance be obtained from an imaging system 38 that imaged a paper check 36. Darkness measurement system 18 could be integrated with the imaging system 38, or be implemented as a separate process. Darkness measurement system 18 includes a code line capture system 20 for cropping/capturing image data associated with the MICR code line 32 from the black white check image 30; a darkness measurement system 22 for measuring a darkness value of the black white check image 30 by analyzing image data associated with the MICR code line 32; and an acceptable image analysis system 26 for determining if the black white check image is acceptable.

Code line capture system 20 can use any known process for capturing/cropping the image data associated with the MICR code line 32 from the black white check image 30. The reason that image data associated with the MICR code line 32 is utilized is because the MICR code line 32 is the only region of a check that uses a standard controlled printing process. In the US, the MICR code line 32 is printed with an industry regulated E13B font. While the E13B print standards allow for some variation in print stroke widths, the MICR code line 32 nonetheless represents the most controlled print region appearing in the black white check image 30.

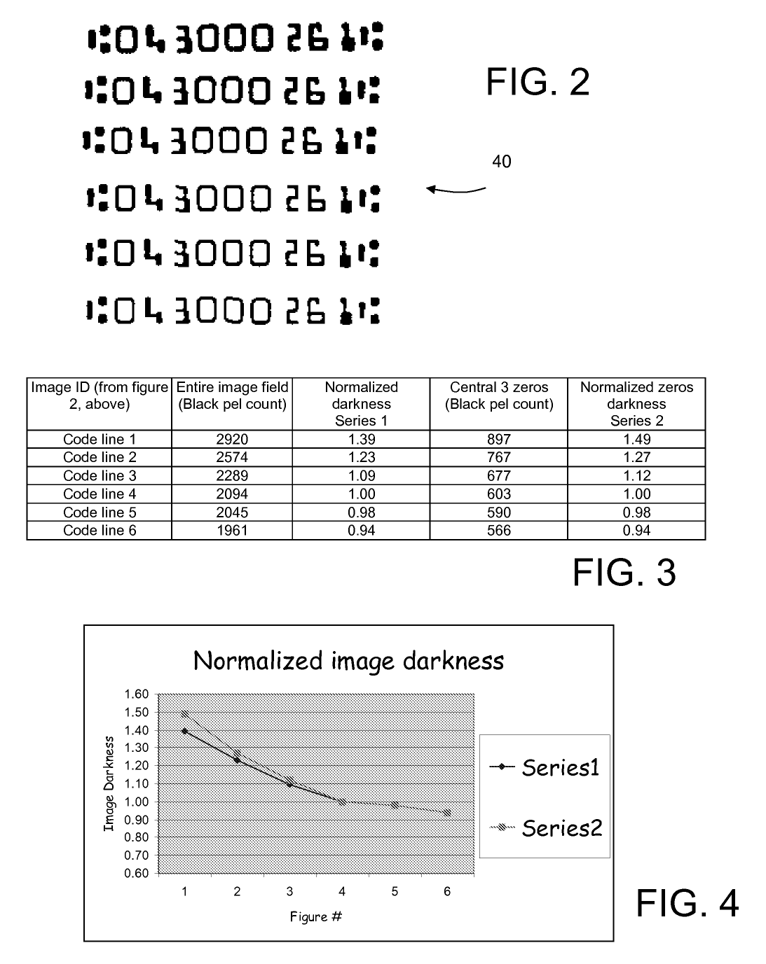

In one illustrative embodiment, image data encompassing the entire MICR code line region is analyzed. In an alternative embodiment, one or more portions of the code line 32 are analyzed. For example, rather than analyzing the entire MICR code line 32, code line capture system 20 could utilize “0” identification system 24 to capture a region from the code line 32 containing a string of zeros. Most MICR code lines 32, such as that shown in FIG. 2, include multiple “0”s. By using known printed values, such as a string of zeros, a more robust measurement can be obtained. Because optical character recognition (OCR) of the code line 32 is typically already practiced by check processing systems 11, the region containing the zeros can be easily extracted. Obviously, other characters or portions of the MICR code line 32 could likewise be utilized.

Darkness measurement system 22 measures a darkness value by simply counting the number of black pixels in a captured region. For the case where the entire MICR code line 32 is captured, the captured region might comprise a rectangle that encompasses the entire MICR code line 32. For the case where only zeros are captured, the captured region may comprise one or more regions that encompass the zero characters. The resulting darkness value may be any type of value, e.g., a total black pixel count, a normalized value, a ratio, an average, etc.

Acceptable image analysis system 26 compares the calculated darkness value to a threshold 28 to determine if the black white check image 30 is acceptable. Threshold 28 may be user adjustable so that the darkness measurement system can be calibrated for the particular need of the user. Once a determination is made, analysis output 34 may be generated. Analysis output 34 may comprise any information, e.g., pass/fail, a counter, darkness measurements, etc., and be outputted in any manner, e.g., to a display, written to memory, etc.

FIG. 2 depicts six illustrative MICR code line samples 40 that range in darkness, with the darkest on top and the lightest on the bottom. Each code line sample is illustrative of how, under different conditions, the same black white information may be captured from a check by an imaging system. As can be seen, each of the code line samples 40 includes three central zeros, typical of many real world code lines. In this illustration, darkness values of the entire code line and the central three zeros are determined for each code line sample and are placed in the table shown in FIG. 3. Darkness values comprise the number of black pixels in the field, i.e., black pel count. In addition, normalized values are determined based on the assumption that code line 4 represents the ideal darkness (i.e., each darkness value is divided by the darkness value of code line 4). FIG. 4 depicts a graph contrasting normalized data for each sample for both the entire code line and the central three zeros. As noted, the use of zeros may allow for a higher level of consistency in measuring darkness.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a darkness measurement system 18 could be created, maintained and/or deployed by a service provider that offers the functions described herein for customers. That is, a service provider could offer to deploy or provide the ability to measure darkness as described above.

It is understood that in addition to being implemented as a system and method, the features may be provided as a program product stored on a computer-readable medium, which when executed, enables computer system 10 to provide a darkness measurement. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A darkness measurement system for measuring darkness of a black white check image, comprising:
a system for capturing MICR code line image data from the black white check image;
a system for determining a darkness value from the captured MICR code line image data; and
a system for determining if the black white check image is acceptable by comparing the darkness value to a threshold, and for outputting a resulting analysis.

2. The darkness measurement system of claim 1, wherein the MICR code line image data consists of image regions containing “0”s.

3. The darkness measurement system of claim 1, wherein the darkness value is determined based on a number of black pixels in the MICR code line image data.

4. The darkness measurement system of claim 3, wherein the darkness value is a normalized value.

5. A computer program product stored on a computer readable medium for measuring darkness of a black white check image, comprising:
program code configured for capturing MICR code line image data from the black white check image;
program code configured for determining a darkness value from the captured MICR code line image data; and
program code configured for determining if the black white check image is acceptable by comparing the darkness value to a threshold, and for outputting a resulting analysis.

6. The computer program product of claim 5, wherein the MICR code line image data consists of at least one image region containing a “0”.

7. The computer program product of claim 5, wherein the darkness value is determined based on a number of black pixels in the MICR code line image data.

8. The computer program product of claim 7, wherein the darkness value is a normalized value.

9. A method for measuring darkness of a black white check image, comprising:
capturing MICR code line image data from the black white check image;
determining a darkness value from the captured MICR code line image data;
determining if the black white check image is acceptable by comparing the darkness value to a threshold; and
outputting a resulting analysis.

10. The method of claim 9, wherein the MICR code line image data consists of at least one image region containing a “0”.

11. The method of claim 9, wherein the darkness value is determined based on a number of black pixels in the MICR code line image data.

12. The method of claim 11, wherein the darkness value is a normalized value.
